(19) United States
(12) Patent Application Publication
(10) Pub. No.: US 2026/0228208 A1
(43) Pub. Date: Aug. 6, 2026

(54) ENSURING DATA INTEGRITY IN REPORTING DATABASE QUERY RESPONSES

(71) Applicant: T-Mobile Innovations LLC, Overland Park, KS (US)

(72) Inventors: Deepesh BELWAL, Ashburn, VA (US); ANUJ Sharma, Broadlands, VA (US); Sriharsha Nagaraja Kadalbal, Sammamish, WA (US); Osama Khamis Mustafa, 26835 225th Avenue SE, WA (US); Kalpana Pinnaka, Bellevue, WA (US)

(21) Appl. No.: 19/044,223

(22) Filed: Feb. 3, 2025

(51) Int. Cl. G06F 16/23; G06F 16/21; G06F 16/27

(52) U.S. Cl. CPC G06F 16/2365; G06F 16/211; G06F 16/27

(57) ABSTRACT

Systems and methods are provided for ensuring data integrity in reporting database query responses. Initially, the schema within a reporting database is updated to add an internal dirty-data bit/attribute per record. In one aspect, if a record with the dirty-data bit/attribute set is part of the result set for a query, the dirty-data bit/attribute is provided to the reporting client along with the result set. In another aspect, the reporting database enhances the incoming query by adding the identity of the portion of the database with stale data to the query filters and communicates the enhanced query to a peer geo-redundant site that does not have a global dirty-data bit/attribute set. The reporting database replaces the stale data in the result set with the portion of data received from the peer and communicates the complete result set to the reporting client.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

In aspects set forth herein, systems and methods are provided for ensuring data integrity in reporting database query responses. More particularly, in aspects set forth herein, data integrity is maintained for all queries to the reporting database and complete data sets are returned. To do so, the schema within a reporting database is updated to add an internal dirty-data bit/attribute per record (e.g., customer, subscriber, document, etc.).

In one aspect, if a record with the dirty-data bit/attribute set is part of the result set for a query, the dirty-data bit/attribute is provided to the reporting client along with the result set. Since the reporting client is aware of a portion of the data being stale, the reporting client can determine to work with only the clean data (such as if the stale data portion being too small to impact the query) or to query an alternate geo-redundant reporting database (or retry at an alternate time).

In another aspect, the reporting database is aware of peer geo-redundant sites. If a record with a dirty-data bit/attribute set is part of the result-set for a query, the reporting database initially enhances the incoming query by adding the identity of the portion of the database with stale data to the query filters. The reporting database also communicates the enhanced query to a peer geo-redundant site that does not have a global dirty-data bit/attribute set and fetches the portion of data from the peer. The reporting database replaces the stale data in the result set with the portion of data received from the peer and communicates the complete result set to the reporting client.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of a first example reporting system in which implementations of the present disclosure may be employed;

FIG. 2 depicts diagram of a second example reporting system in which implementations of the present disclosure may be employed;

FIG. 3 depicts a flow diagram of a first example method of ensuring data integrity in reporting database query responses, in accordance with aspects herein;

FIG. 4 depicts a flow diagram of a second example method of ensuring data integrity in reporting database query responses, in accordance with aspects herein; and

FIG. 5 illustrates an example computing device for use with the present disclosure.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
6G Sixth-Generation Cellular Communication System
AI Artificial Intelligence
CD-ROM Compact Disk Read Only Memory
CDMA Code Division Multiple Access
eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
MIMO Multiple Input Multiple Output
MD Mobile Device
ML Machine Learning
PC Personal Computer
PCS Personal Communications Service
PDA Personal Digital Assistant
PDSCH Physical Downlink Shared Channel
PHICH Physical Hybrid ARQ Indicator Channel
PUCCH Physical Uplink Control Channel
PUSCH Physical Uplink Shared Channel
RAM Random Access Memory
RET Remote Electrical Tilt
RF Radio-Frequency
RFI Radio-Frequency Interference
R/N Relay Node
RNR Reverse Noise Rise
ROM Read Only Memory
RSRP Reference Signal Receive Power
RSRQ Reference Signal Receive Quality
RSSI Received Signal Strength Indicator
SINR Transmission-to-Interference-Plus-Noise Ratio
SNR Transmission-to-noise ratio
SON Self-Organizing Networks
TDMA Time Division Multiple Access
TXRU Transceiver (or Transceiver Unit)
UE User Equipment
UMTS Universal Mobile Telecommunications Systems
WCD Wireless Communication Device (interchangeable with UE)

Further, various technical terms are used throughout this description. An illustrative resource that fleshes out various aspects of these terms can be found in Newton's Telecom Dictionary, 32^{nd} Edition (2022).

In conventional technologies, databases are deployed in many organizations and updated in real-time for a large number of records. For example, subscription databases in telecommunications technologies or customer databases in banking technologies rely on real-time updates. Since there is always a need for generating reports for various purposes, organizations deploy other databases that may serve as reporting databases. These databases are updated with data snapshots of live databases at periodic intervals or in a near real-time manner using event-based triggers originating from the live databases.

In many cases, the reporting databases are updated in near-real time for partial updates or all updates occurring within the live databases. In a first telecommunications example, near real-time synchronization of the reporting database for all subscriber provisioning events in the mobile network operator MNO network is needed from the real-time database. In another telecommunications example, near real-time synchronization of the reporting database for all update operations in the MNO network is needed from the real-time database.

Large-scale databases catering to high query and update traffic in organizations are often deployed in a geo-redundant manner. Reporting databases may also be deployed in a similar manner to ensure high-availability, with each site being synched with its corresponding nearest real-time database site. Due to the high speed required for updates, the reporting database geo-redundant sites may operate as independent databases instead of a as a database cluster, with no synchronization mechanism between the sites. As a result, various reporting database sites may store variations of data due to synchronization status with the live database(s).

Both live and reporting databases often structure data into different mutually-exclusive subsets with each subset catering to a different set of subscriptions. Thus, a complete snapshot of the data may be distributed across different storage clusters, data-spaces, data-pages, and the like. Various event-based trigger mechanisms may be used to keep the reporting databases in sync with updates happening at live databases. For example, an asynchronous ordered triggering method (e.g., Simple Object Access Protocol/Hypertext Transfer Protocol) may be utilized to sync the reporting databases with the live databases. In another example, a message bus based triggering method (e.g., APACHE KAKFA/RABBITMQ/AMAZON SIMPLE QUEUE SERVICE) may be utilized to sync the reporting databases with the live databases.

However, in conventional large-scale databases, some event-based triggers may get lost in the network or during processing, creating a gap in the trigger sequence. These gaps result in a portion of the reporting database not including the latest updates from the live database. Moreover, further updates to that portion of data may result in additional deficiencies of data-integrity. Depending upon how the database is structured, a sizable set of data may be out of sync. Due to high-availability requirements, reporting databases may not declare themselves off-limits for clients when they experience issues with portions of data not being in sync.

In some instances, queries to the reporting databases may receive stale data and there may be no way of determining which portion or how much of a portion of the data is stale. If the reporting databases use the stale data from these queries for further action (e.g., update the live database if the subscription meets certain criteria), unintended customers may experience service disruptions and service for already impacted customers may not be corrected.

Some conventional systems leverage alert generation when a data sync issue is reported. If the network operations center or operations team receives an alert, the impacted database must be taken offline (based on current availability needs) or the reporting clients must be notified of the issue so manual decisions can be taken to utilize determine how to use the potentially stale data. This approach suffers from reduced availability and no indication on which portion or how much of a portion of the data is affected.

Other conventional systems take the reporting database offline when a data sync issue is detected. Although this prevents stale data from being reported to the reporting clients, availability is reduced, which may not be desirable or practical. Some conventional systems may support a refresh of the complete live database or a portion of the live database that was impacted. This may be accomplished utilizing a newly created snapshot of the live database and generally occurs during a planned maintenance period or an emergency maintenance period. Once the impacted reporting database is reloaded and synced with the corresponding live database, it is available to receive queries from reporting clients and provide up-to-date data.

The present disclosure is directed to ensuring data integrity in reporting database query responses. More particularly, the present disclosure enables a reporting client to be aware when stale data is present within a reporting database and/or when stale data is in a result set corresponding to a query executed against a reporting database. Moreover, the present disclosure enables a reporting database with stale data to communicate an enhanced query to a peer geo-redundant site and replace the stale data with data from the peer so a complete result set can be provided to the reporting client.

To do so, the schema within the reporting database is updated to add an internal dirty-data bit/attribute per record (e.g., customer, subscriber, document, etc.). Since the reporting database is aware which portion of data is having sync issues, all records related to that portion have the internal dirty-data bit/attribute set.

In one aspect, if a record with the dirty-data bit/attribute set is part of the result set for a query, the dirty-data bit/attribute is provided to the reporting client along with the result set. The dirty-data bit/attribute may be the last attribute present in the records being returned (e.g., last column of the result set), keeping the post-processing logic intact. Since the reporting client is aware of a portion of the data being stale, the reporting client can determine to work with only the clean data (such as if the stale data portion being too small to impact the query) or to query an alternate geo-redundant reporting database (or retry at an alternate time).

In another aspect, the reporting database is aware of peer geo-redundant sites (e.g., the reporting site is not deployed as part of a cluster and is not synch with the peer geo-redundant sites). If a record with a dirty-data bit/attribute set is part of the result-set for a query, the reporting database initially enhances the incoming query by adding the identity of the portion of the database with stale data to the query filters. The reporting database also communicates the enhanced query to a peer geo-redundant site that does not have a global dirty-data bit/attribute set and fetches the portion of data from the peer. The reporting database replaces the stale data in the result set with the portion of data received from the peer and communicates the complete result set to the reporting client.

In aspects, the reporting database sets a global flag for the affected reporting database to indicate it contains records with a dirty data bit/attribute set. When the portion of the database is re-synced with a fresh snapshot of the live database as part of next available maintenance or emergency maintenance cycle of the live-database, the dirty-data bit/attribute is reset (along with global flag for the affected reporting database).

In aspects, the present disclosure can be implemented across a variety of database platforms including traditional relational database management systems (RDBMS), lightweight directory access protocol LDAP and other directory-based database systems, document-based database systems, and the like. Aspects of the present disclosure ensure data integrity is maintained for all queries to the reporting database and a complete data set is returned. Moreover, aspects of the present disclosure ensure high availability of the reporting database.

Accordingly, in a first aspect of the present invention, computer-readable media is provided, the computer-readable media having computer-executable instructions embodied thereon that, when executed, perform a method of ensuring data integrity in reporting database query responses. The method comprise updating a schema at a reporting engine to add a dirty-data bit/attribute per record of one or more reporting databases. The method also comprises receiving a first query from a reporting client at the reporting engine. The method further comprises retrieving by the reporting engine a result set from a first reporting database of the one or more reporting databases, wherein a record in a first reporting database of the one or more reporting databases has the dirty-data bit/attribute set and is part of a result set for the first query. The method also comprises communicating the result set to the reporting client, the result set including the record and the dirty-data bit/attribute indicating stale data is present.

A second aspect of the present disclosure is directed to a method of ensuring data integrity in reporting database query responses. The method comprises updating a schema at a reporting engine to add a dirty-data bit/attribute per record of one or more reporting databases. The method also comprises receiving a first query from a reporting client at the reporting engine. The method further comprises determining, at the reporting engine, a record in a first reporting database of the one or more reporting databases has the dirty-data bit/attribute set and is part of a result set for the first query. The method also comprises enhancing the first query to identify the record with the dirty-data bit/attribute set. The method further comprises communicating the enhanced query to a second reporting database of the one or more reporting databases. The method also comprises retrieving a synchronized record from the second reporting database. The method further comprise replacing the record with the dirty-data bit/attributed set from the first reporting database with the synchronized record from the second reporting database. The method also comprises communicating a complete result set to the reporting client, the complete result set including the synchronized record from the second reporting database.

Another aspect of the present disclosure is directed to a system for ensuring data integrity in reporting database query responses. The system comprises a reporting engine in communication with one or more reporting databases and one or more reporting clients. The reporting engine is configured to: update a schema at a reporting engine to add an dirty-data bit/attribute per record of one or more reporting databases; receive a first query from a reporting client at the reporting engine; retrieve by the reporting engine a result set from a first reporting database of the one or more reporting databases, wherein a record in a first reporting database of the one or more reporting databases has the dirty-data bit/attribute set and is part of a result set for the first query; and 1) communicate the result set to the reporting client, the result set including the record and the dirty-data bit/attribute indicating stale data is present; or 2) enhance the first query to identify the record with the dirty-data bit/attribute set; communicating the enhanced query to a second reporting database of the one or more reporting databases; retrieve a synchronized record from the second reporting database; replace the record with the dirty-data bit/attributed set from the first reporting database with the synchronized record from the second reporting database; and communicate a complete result set to the reporting client, the complete result set including the synchronized record from the second reporting database.

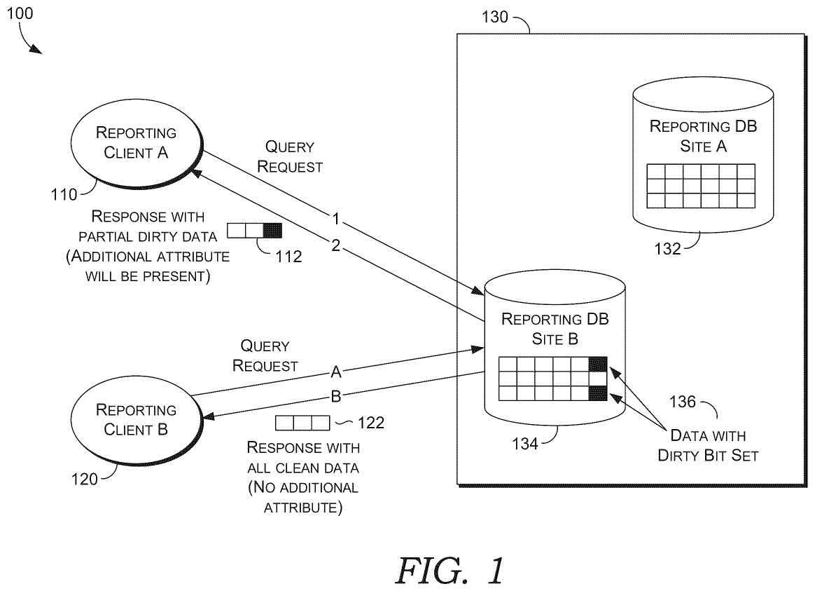

FIG. 1 depicts a diagram of a first example reporting system in which implementations of the present disclosure may be employed. Such a reporting system is illustrated and designated generally as environment 100. Environment 100 is not to be interpreted as having any dependency or requirement relating to any one or combination of components illustrated.

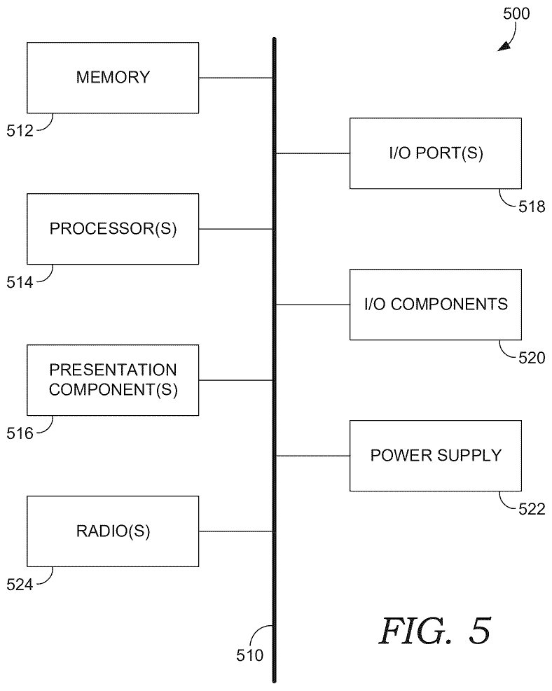

Environment 100 includes reporting client A 110, reporting client B 120, reporting engine 130, reporting database site A 132, and reporting database site B 134. In environment 100, reporting client A 110 and reporting client B 120 may take on a variety of forms, such as a personal computer (PC), a user device, a smart phone, a smart watch, a laptop computer, a mobile phone, a mobile device, a tablet computer, a wearable computer, a personal digital assistant (PDA), a server, a CD player, an MP3 player, a global positioning system (GPS) device, a video player, a handheld communications device, a workstation, a router, a hotspot, and any combination of these delineated devices, or any other device (such as the computing device 500 in FIG. 5).

In some aspects, reporting client A 110, reporting client B 120, and reporting engine 130 may correspond to computing device 500 in FIG. 5. Thus, a reporting client and/or reporting engine can include, for example, a display(s), a power source(s) (e.g., a battery), a data store(s), a speaker(s), memory, a buffer(s), a radio(s) and the like. In some cases, reporting client A 110 and reporting client B 120, in environment 100 can optionally utilize one or more communication channels to communicate with other computing devices (e.g., a mobile device(s), a server(s), a personal computer(s), etc.). For example, reporting client A 110 and reporting client B 120 may utilize one or more communication channels to communicate with reporting engine 130 or components of reporting engine 130 (e.g., reporting database site A 132 and reporting database site B 134).

The reporting engine 130 is generally configured to enable reporting client A 110 and reporting client B 120 to execute queries against reporting database site A 132 and reporting database site B 134. Each of reporting database site A 132 and reporting database site B 134 comprises data that may be updated in real-time or near real-time with data from one or more live databases (not shown in FIG. 1). For example, in a telecommunications example, the data may include subscriber provisioning data and/or network application-based dynamic updates. In a banking example, the data may include customer information, transaction data, and the like.

In practice, reporting client A 110 issues a query request to reporting database site B 134 via reporting engine 130. As shown, reporting database site B 134 comprises one or more portions of stale data as indicated by the dirty-data bit/attribute 136 being set. In the response, the result set 112 is communicated to reporting client A 110 along with the dirty-data bit/attribute 136 indicating stale data is present in the result set.

In another example, reporting client B 120 issues a query request to reporting database site B 134 via reporting engine 130. Now assume reporting database site B 134 has been updated by reporting database site A 132, for example, after the query request was issued by reporting client A 110. In this case, the dirty-data bit/attribute 136 has been reset by reporting engine 130, indicating a complete data set is present within reporting database site B 134. Accordingly, a complete result set 122 is communicated to reporting client B 120 without a dirty-data bit/attribute 136 being set indicating there is no stale data present in the result set.

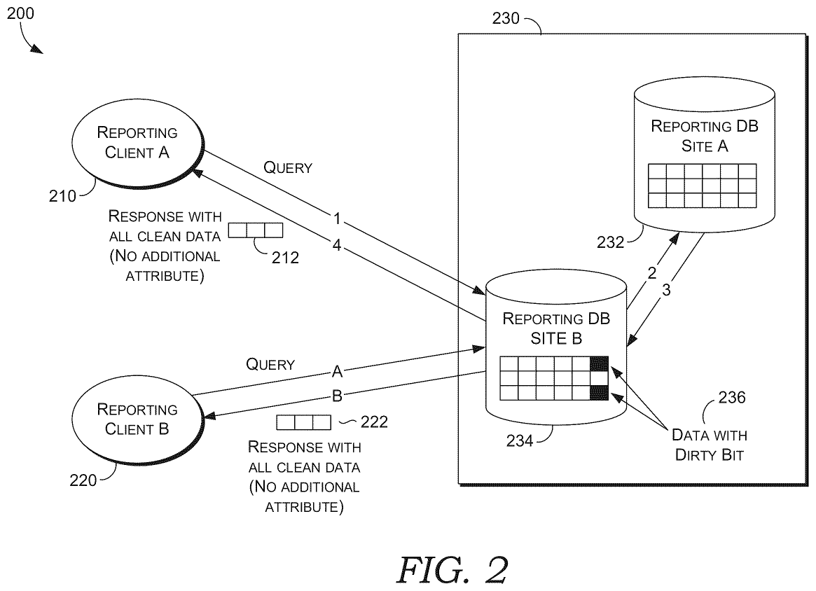

Turning now to FIG. 2, a diagram of a second example reporting system in which implementations of the present disclosure may be employed is depicted. Such a reporting system is illustrated and designated generally as environment 200. Environment 200 is not to be interpreted as having any dependency or requirement relating to any one or combination of components illustrated.

Environment 200 also includes reporting client A 210, reporting client B 220, reporting engine 230, reporting database site A 232, reporting database site B 234. In environment 200, reporting client A 210 and reporting client B 220 may take on a variety of forms, such as a personal computer (PC), a user device, a smart phone, a smart watch, a laptop computer, a mobile phone, a mobile device, a tablet computer, a wearable computer, a personal digital assistant (PDA), a server, a CD player, an MP3 player, a global positioning system (GPS) device, a video player, a handheld communications device, a workstation, a router, a hotspot, and any combination of these delineated devices, or any other device (such as the computing device 500 in FIG. 5).

In some aspects, reporting client A 210, reporting client B 220, and reporting engine 230 may correspond to computing device 500 in FIG. 5. Thus, a reporting client and/or reporting engine can include, for example, a display(s), a power source(s) (e.g., a battery), a data store(s), a speaker(s), memory, a buffer(s), a radio(s) and the like. In some cases, reporting client A 210 and reporting client B 220, in environment 200 can optionally utilize one or more communication channels to communicate with other computing devices (e.g., a mobile device(s), a server(s), a personal computer(s), etc.). For example, reporting client A 210 and reporting client B 220 may utilize one or more communication channels to communicate with reporting engine 230 or components of reporting engine 230 (e.g., reporting database site A 232 and reporting database site B 234).

The reporting engine 230 is generally configured to enable reporting client A 210 and reporting client B 220 to execute queries against reporting database site A 232 and reporting database site B 234. Each of reporting database site A 232 and reporting database site B 234 comprises data that may be updated in real-time or near real-time with data from one or more live databases (not shown in FIG. 2). For example, in a telecommunications example, the data may include subscriber provisioning data and/or network application-based dynamic updates. In a banking example, the data may include customer information, transaction data, and the like.

In practice, reporting client A 210 issues a query request to reporting database site B 234 via reporting engine 230. As shown, reporting database site B 234 comprises one or more portions of stale data as indicated by the dirty-data bit/attribute 236 being set. Reporting database site B 234 is aware of peer geo-redundant sites (e.g., reporting database site A 232). If a record with dirty-data bit/attribute set 236 is part of the result-set for a query, reporting database site B 234 or reporting engine 230 enhances the incoming query by adding the identity of the portion of the database with stale data to the query filters. The enhanced query is communicated to the peer geo-redundant site (e.g., reporting database site A 232) to retrieve the portion of data that is not up-to-date in reporting database site B 234. The stale data within the result set is replaced by reporting engine 230 with data received from the peer and the complete result set 212 is communicated to the reporting client A 210.

In another example, reporting client B 220 issues a query request to reporting database site B 234 via reporting engine 230. Now assume reporting database site B 234 has been updated since the query request was issued by reporting client A 210. In this case, the dirty-data bit/attribute 236 has been reset by reporting engine 230, indicating a complete data set is present within reporting database site B 234. Accordingly, a complete result 222 set is communicated to reporting client B 220 without a dirty-data bit/attribute 236 being set indicating there is no stale data present in the result set.

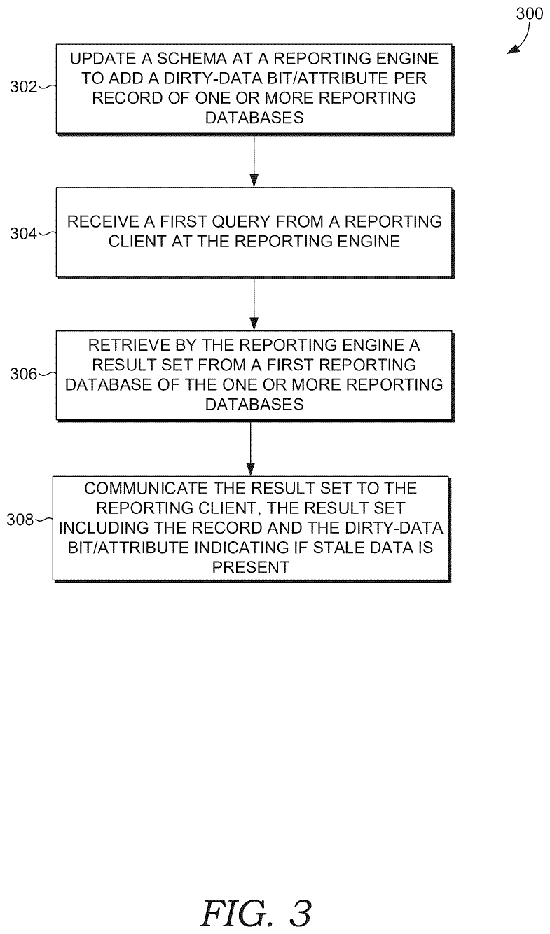

In FIG. 3, a flow diagram is provided depicting a method 300 for enhancing 5G coverage optimization, in accordance with aspects of the present invention. Method 300 may be performed by any computing device (such as computing device described with respect to FIG. 5) with access to reporting engine (such as the one described with respect to FIG. 1 or 2) or by one or more components of the environment described with respect to FIG. 1 or 2.

Initially, at step 302, a schema is updated at a reporting engine to add a dirty-data bit/attribute per record of one or more reporting databases. In some aspects, the dirty-data bit/attribute is in a last column of the result set.

At step 304, a first query is received from a reporting client at the reporting engine. In some aspects, the reporting engine sets the dirty-data bit/attribute for each record having synchronization issues in the first reporting database of the one or more reporting databases. In some aspects, the reporting engine sets a global flag for the first database of the one or more reporting databases indicating the first database contains records with the dirty data bit/attribute set.

At step 306, a result set is retrieved, by the reporting engine, from a first reporting database of the one or more reporting databases. A record in a first reporting database of the one or more reporting databases has the dirty-data bit/attribute set and is part of a result set for the first query.

At step 308, the result set is communicated to the reporting client. The result set includes the record and the dirty-data bit/attribute indicating stale data is present.

In some aspects, a second query is received at the reporting engine. The second query is executed at a second reporting database of the one or more reporting databases. If the second reporting database has been synchronized with the live database, a complete result set corresponding to the second query can be provided. For clarity, the complete result set does not have stale data.

In some aspects, the first reporting database of the one or more reporting databases is synchronized with the live database. Once synchronized, the dirty data bit/attribute for each record in the first reporting database of the one or more reporting databases that has been updated is reset. Additionally or alternatively, the global flag for the first reporting database of the one or more reporting databases is reset, indicating the first database has been updated. Once the dirty data bit/attribute and the global flag have been reset, the first query may be received again at the reporting engine. A complete result set corresponding to the first query may then be provided to the reporting client. For clarity, the complete result set does not have stale data.

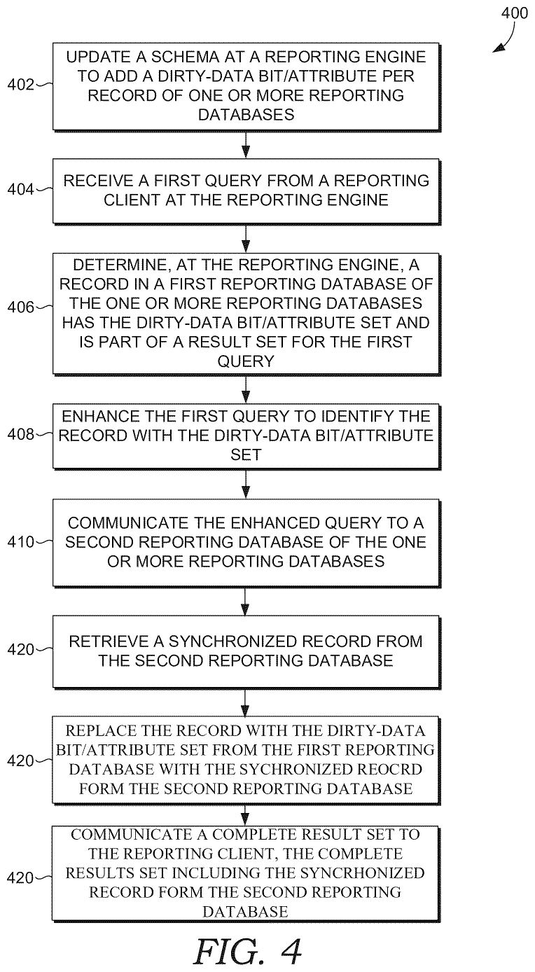

In FIG. 4, a flow diagram is provided depicting a method 400 for enhancing 5G coverage optimization, in accordance with aspects of the present invention. Method 400 may be performed by any computing device (such as computing device described with respect to FIG. 5) with access to reporting engine (such as the one described with respect to FIG. 1 or 2) or by one or more components of the environment described with respect to FIG. 1 or 2.

Initially, at step 402, a schema is updated at a reporting engine to add a dirty-data bit/attribute per record of one or more reporting databases. In some aspects, the dirty-data bit/attribute is transparent to the reporting client.

At step 404, a first query is received from a reporting client at the reporting engine. In some aspects, the reporting engine sets the dirty-data bit/attribute for each record having synchronization issues in the first reporting database of the one or more reporting databases. In some aspects, the reporting engine sets a global flag for the first database of the one or more reporting databases indicating the first database contains records with the dirty data bit/attribute set.

At step 406, a record in a first reporting database of the one or more reporting databases is determined, by the reporting engine, to have the dirty-data bit/attribute set and is part of a result set for the first query.

At step, 408, the first query is enhanced to identify the record with the dirty-data bit/attribute set. The enhanced query is communicated, at step 410, to a second reporting database of the one or more reporting databases. At step 412, a synchronized record is received from the second reporting database. The record is replaced, at step 414, with the dirty-data bit/attributed set from the first reporting database with the synchronized record from the second reporting database. At step 416, a complete result set is communicated to the reporting client. For clarity, the complete result set does not have stale data.

In some aspects, the first reporting database of the one or more reporting databases is synchronized with the live database. Once synchronized, the dirty data bit/attribute for each record in the first reporting database of the one or more reporting databases that has been updated is reset. Additionally or alternatively, the global flag for the first reporting database of the one or more reporting databases is reset, indicating the first database has been updated.

Embodiments of the technology described herein may be embodied as, among other things, a method, a system, or a computer-program product. Accordingly, the embodiments may take the form of a hardware embodiment, or an embodiment combining software and hardware. The present technology may take the form of a computer-program product that includes computer-useable instructions embodied on one or more computer-readable media. The present technology may further be implemented as hard-coded into the mechanical design of network components and/or may be built into a broadcast cell or central server.

Computer-readable media includes both volatile and non-volatile, removable and non-removable media, and contemplate media readable by a database, a switch, and/or various other network devices. Network switches, routers, and related components are conventional in nature, as are methods of communicating with the same. By way of example, and not limitation, computer-readable media may comprise computer storage media and/or non-transitory communications media.

Computer storage media, or machine-readable media, may include media implemented in any method or technology for storing information. Examples of stored information include computer-useable instructions, data structures, program modules, and other data representations. Computer storage media may include, but are not limited to, RAM, ROM, EEPROM, flash memory or other memory technology, CD-ROM, digital versatile discs (DVD), holographic media or other optical disc storage, magnetic cassettes, magnetic tape, magnetic disk storage, and/or other magnetic storage devices. These memory components may store data momentarily, temporarily, and/or permanently, and are not limited to the examples provided.

Communications media typically store computer-useable instructions-including data structures and program modules-in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

Referring to FIG. 5, a block diagram of an exemplary computing device 500 suitable for use in implementations of the technology described herein is provided. In particular, the exemplary computer environment is shown and designated generally as computing device 500. Computing device 500 is but one example of a suitable computing environment and is not intended to suggest any limitation as to the scope of use or functionality of the invention. Neither should computing device 500 be interpreted as having any dependency or requirement relating to any one or combination of components illustrated. It should be noted that although some components in FIG. 5 are shown in the singular, they may be plural. For example, the computing device 500 might include multiple processors or multiple radios. In aspects, the computing device 500 may be a UE/WCD, or other user device, capable of two-way wireless communications with an access point. Some non-limiting examples of the computing device 500 include a cell phone, tablet, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 5, computing device 500 includes a bus 510 that directly or indirectly couples various components together, including memory 512, processor(s) 514, presentation component(s) 516 (if applicable), radio(s) 524, input/output (I/O) port(s) 518, input/output (I/O) component(s) 520, and power supply(s) 522. Although the components of FIG. 5 are shown with lines for the sake of clarity, in reality, delineating various components is not so clear, and metaphorically, the lines would more accurately be grey and fuzzy. For example, one may consider a presentation component such as a display device to be one of I/O components 520. Also, processors, such as one or more processors 514, have memory. The present disclosure hereof recognizes that such is the nature of the art, and reiterates that FIG. 5 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 512 may take the form of memory components described herein. Thus, further elaboration will not be provided here, but it should be noted that memory 512 may include any type of tangible medium that is capable of storing information, such as a database. A database may be any collection of records, data, and/or information. In one embodiment, memory 512 may include a set of embodied computer-executable instructions that, when executed, facilitate various functions or elements disclosed herein. These embodied instructions will variously be referred to as “instructions” or an “application” for short.

Processor 514 may actually be multiple processors that receive instructions and process them accordingly. Presentation component 516 may include a display, a speaker, and/or other components that may present information (e.g., a display, a screen, a lamp (LED), a graphical user interface (GUI), and/or even lighted keyboards) through visual, auditory, and/or other tactile cues.

Radio 524 represents a radio that facilitates communication with a wireless telecommunications network. Illustrative wireless telecommunications technologies include CDMA, GPRS, TDMA, GSM, and the like. Radio 524 might additionally or alternatively facilitate other types of wireless communications including Wi-Fi, WiMAX, LTE, 3G, 4G, LTE, mMIMO/5G, NR, VoLTE, or other VoIP communications. As can be appreciated, in various embodiments, radio 524 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

The input/output (I/O) ports 518 may take a variety of forms. Exemplary I/O ports may include a USB jack, a stereo jack, an infrared port, a firewire port, other proprietary communications ports, and the like. Input/output (I/O) components 520 may comprise keyboards, microphones, speakers, touchscreens, and/or any other item usable to directly or indirectly input data into the computing device 500.

Power supply 522 may include batteries, fuel cells, and/or any other component that may act as a power source to supply power to the computing device 500 or to other network components, including through one or more electrical connections or couplings. Power supply 522 may be configured to selectively supply power to different components independently and/or concurrently.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

1. One or more non-transitory computer-readable media having computer-executable instructions embodied thereon that, when executed, perform a method of ensuring data integrity in reporting database query responses, the method comprising:
updating a schema at a reporting engine to add a dirty-data bit/attribute per record of one or more reporting databases, wherein the dirty-data bit/attribute is inserted as a last attribute of each record of the one or more reporting databases;
receiving a first query from a reporting client at the reporting engine;
retrieving by the reporting engine a result set from a first reporting database of the one or more reporting databases, wherein a record in a first reporting database of the one or more reporting databases has the dirty-data bit/attribute set and is part of a result set for the first query; and
communicating the result set to the reporting client, the result set including the record and the dirty-data bit/attribute indicating stale data is present.

2. The non-transitory media of claim 1, wherein the dirty-data bit/attribute is in a last column of the result set.

3. The non-transitory media of claim 1, further comprising setting by the reporting engine, the dirty-data bit/attribute for each record having synchronization issues in the first reporting database of the one or more reporting databases.

4. The non-transitory media of claim 3, further comprising, setting by the reporting engine, a global flag for the first database of the one or more reporting databases indicating the first database contains records with the dirty data bit/attribute set.

5. The non-transitory media of claim 4, further comprising receiving a second query at the reporting engine, the second query executed at a second reporting database of the one or more reporting databases.

6. The non-transitory media of claim 5, further comprising providing a complete result set corresponding to the second query, the complete result set not having stale data.

7. The non-transitory media of claim 4, further comprising synchronizing the first reporting database of the one or more reporting databases with a live database.

8. The non-transitory media of claim 7, further comprising resetting the dirty data bit/attribute for each record in the first reporting database of the one or more reporting databases that has been updated.

9. The non-transitory media of claim 8, further comprising resetting the global flag for the first reporting database of the one or more reporting databases indicating the first database has been updated.

10. The non-transitory media of claim 7, further comprising receiving the first query at the reporting engine, the first query executed at first reporting database of the one or more reporting databases after the first reporting database is synchronized with the live database and the dirty-data bit/attribute is reset.

11. The non-transitory media of claim 10, further comprising providing a complete result set corresponding to the first query, the complete result set not having stale data.

12. A method of ensuring data integrity in reporting database query responses, the method comprising:
updating a schema at a reporting engine to add a dirty-data bit/attribute per record of one or more reporting databases, wherein the dirty-data bit/attribute is inserted as a last attribute of each record of the one or more reporting databases;
receiving a first query from a reporting client at the reporting engine;
determining, at the reporting engine, a record in a first reporting database of the one or more reporting databases has the dirty-data bit/attribute set and is part of a result set for the first query;
enhancing the first query to identify the record with the dirty-data bit/attribute set;
communicating the enhanced query to a second reporting database of the one or more reporting databases;
retrieving a synchronized record from the second reporting database;
replacing the record with the dirty-data bit/attributed set from the first reporting database with the synchronized record from the second reporting database; and
communicating a complete result set to the reporting client, the complete result set including the synchronized record from the second reporting database.

13. The method of claim 12, wherein the dirty-data bit/attribute is transparent to the reporting client.

14. The method of claim 12, further comprising setting by the reporting engine, the dirty-data bit/attribute for each record having synchronization issues in the first reporting database of the one or more reporting databases.

15. The method of claim 14, further comprising, setting by the reporting engine, a global flag for the first database of the one or more reporting databases indicating the first database contains records with the dirty data bit/attribute set.

16. The method of claim 15, further comprising synchronizing the first reporting database of the one or more reporting databases with a live database.

17. The method of claim 16, further comprising resetting the dirty data bit/attribute for each record in the first reporting database of the one or more reporting databases that has been updated.

18. The method of claim 17, further comprising resetting the global flag for the first reporting database of the one or more reporting databases indicating the first database has been updated.

19. A system for ensuring data integrity in reporting database query responses, the system comprising:
one or more reporting databases;
a reporting engine in communication with the one or more reporting databases, wherein the reporting engine is configured to:
update a schema at a reporting engine to add a dirty-data bit/attribute per record of one or more reporting databases, wherein the dirty-data bit/attribute is inserted as a last attribute of each record of the one or more reporting databases;
receive a first query from a reporting client at the reporting engine;
retrieve by the reporting engine a result set from a first reporting database of the one or more reporting databases, wherein a record in a first reporting database of the one or more reporting databases has the dirty-data bit/attribute set and is part of a result set for the first query; and
(1) communicate the result set to the reporting client, the result set including the record and the dirty-data bit/attribute indicating stale data is present; or
(2) enhance the first query to identify the record with the dirty-data bit/attribute set; communicate the enhanced query to a second reporting database of the one or more reporting databases; retrieve a synchronized record from the second reporting database; replace the record with the dirty-data bit/attributed set from the first reporting database with the synchronized record from the second reporting database; and communicate a complete result set to the reporting client, the complete result set including the synchronized record from the second reporting database.

20. The system of claim 19, further comprising:
synchronizing the first reporting database of the one or more reporting databases with a live database; and
resetting the dirty data bit/attribute for each record in the first reporting database of the one or more reporting databases that has been updated.
